(19) United States
(12) Patent Application Publication
(10) Pub. No.: US 2016/0098641 A1
(43) Pub. Date: Apr. 7, 2016

(54) GENERATION APPARATUS, SELECTION APPARATUS, GENERATION METHOD, SELECTION METHOD AND PROGRAM

(71) Applicant: INTERNATIONAL BUSINESS MACHINES CORPORATION, Armonk, NY (US)

(72) Inventor: TAKAYUKI OSOGAMI, Tokyo (JP)

(21) Appl. No.: 14/873,422

(22) Filed: Oct. 2, 2015

(30) Foreign Application Priority Data
Oct. 2, 2014 (JP) 2014-203631

(51) Int. Cl. G06N 5/04; G06F 17/16; G06N 7/00

(52) U.S. Cl. CPC G06N 5/045; G06N 7/005; G06F 17/16

(57) ABSTRACT

A generation apparatus generates gain vectors for calculating cumulative expected gains for a transition model in which transition from a current state to a next state occurs in response to an action. The apparatus includes: an acquisition section that acquires gain vectors for a time point next to a target time point that includes cumulative expected gains for and after the next time point for each state at the next time point; a first determination section that determines a value of a transition parameter used for transitioning from the target time point to the next time point, from a valid range of the transition parameter, based on the cumulative expected gains obtained for the gain vectors for the next time point; and a first generation section that generates gain vectors for the target time point from the gain vectors for the next time point, using the transition parameter.

### CROSS-REFERENCE TO RELATED APPLICATIONS

This U.S. non-provisional patent application claims priority under 35 U.S.C. §119 from, and the benefit of, Japanese Patent Application No. 2014-203631, filed on Oct. 2, 2014, the contents of which are herein incorporated by reference in their entirety.

### TECHNICAL FIELD

Embodiments of the present disclosure are directed to a generation apparatus, a selection apparatus, a generation method, a selection method and a program.

### DISCUSSION OF THE RELATED ART

It is known that sequential decision making in an uncertain environment that includes an unobservable state can be modeled as a partially observable Markov decision process (POMDP) and optimized. A POMDP can be applied to robot control, a dialog system, support for dementia patients, etc. In such examples, a predetermined scalar value can be used as a parameter, such as a state transition probability and an observation probability, for a POMDP

However, it can be challenging to accurately estimate a parameter value for a POMDP in advance. Further, when the parameter value deviates from an actual value, an optimum result may not be obtainable even if an optimum decision making strategy is calculated based on a POMDP with the use of such a parameter.

### SUMMARY

In an embodiment of the present disclosure, there is provided a generation apparatus that generates gain vectors for a transition, the apparatus including: an acquisition section that acquires gain vectors for a next time point after a target time point that include cumulative expected gains obtained for and after the next time point for each state at the next time point; a first determination section that determines a value of a transition parameter used for transitioning from the target time point to the next time point, from a valid range of the transition parameter, based on the cumulative expected gains obtained from the gain vectors for the next time point; and a first generation section that generates gain vectors for the target time point from the gain vectors for the next time point, using the transition parameter, where the gain vectors are used to calculate cumulative expected gains in which transition from a current state to a next state occurs in response to an action.

In another embodiment of the present disclosure, there is provided a selection apparatus that selecting an action in a transition, the apparatus including: a set acquisition section that acquires a set of gain vectors for a target time point that include cumulative expected gains obtained for and after the target time point, for each state at the target time point; a probability acquisition section that acquires an assumed probability of being in each state at the target time point; a selection section that selects a gain vector from the set of gain vectors based on the set of gain vectors and the assumed probability; an output section that selects and outputs an action corresponding to the selected gain vector as an action; a second determination section that determines a value of a transition parameter used to transition from the target time point to a next time point, from a valid range of the transition parameter; and a second generation section that generates an assumed probability of being in each state at the next time point after the target time point, using the transition parameter, where a transition from a current state to a next state occurs in response to an action.

### BRIEF DESCRIPTION OF DRAWINGS

FIG. 1 shows an exemplary configuration of a generation apparatus according to a present embodiment.

FIG. 2 is a flowchart of a method of operation of a generation apparatus according to a present embodiment.

FIG. 3 shows an example of a specific algorithm of the operation of FIG. 2.

FIG. 4 shows another example of a specific algorithm of the operation flow of FIG. 2.

FIG. 5 shows a relationship between a set of gain vectors and cumulative expected gains according to a present embodiment.

FIG. 6 shows a gain function that returns a maximum value of the cumulative expected gains according to a present embodiment.

FIG. 7 shows a modification of the relationship between a set of gain vectors and the cumulative expected gains according to a present embodiment.

FIG. 8 shows a gain function that returns a maximum value of the cumulative expected gains corresponding to a modification in FIG. 7.

FIG. 9 shows an example of a specific algorithm of the operation flow in FIG. 2.

FIG. 10 shows an exemplary configuration of a selection apparatus according to a present embodiment.

FIG. 11 shows an operation of a selection apparatus according to a present embodiment.

FIG. 12 shows an example of a hardware configuration of a computer 1900.

### DETAILED DESCRIPTION

The present disclosure will be described below through an embodiment of the disclosure. The embodiment below, however, does not limit the disclosure according to Scope of Claims. Further, all combinations of features described in the embodiment are not necessarily required for solving means of the disclosure.

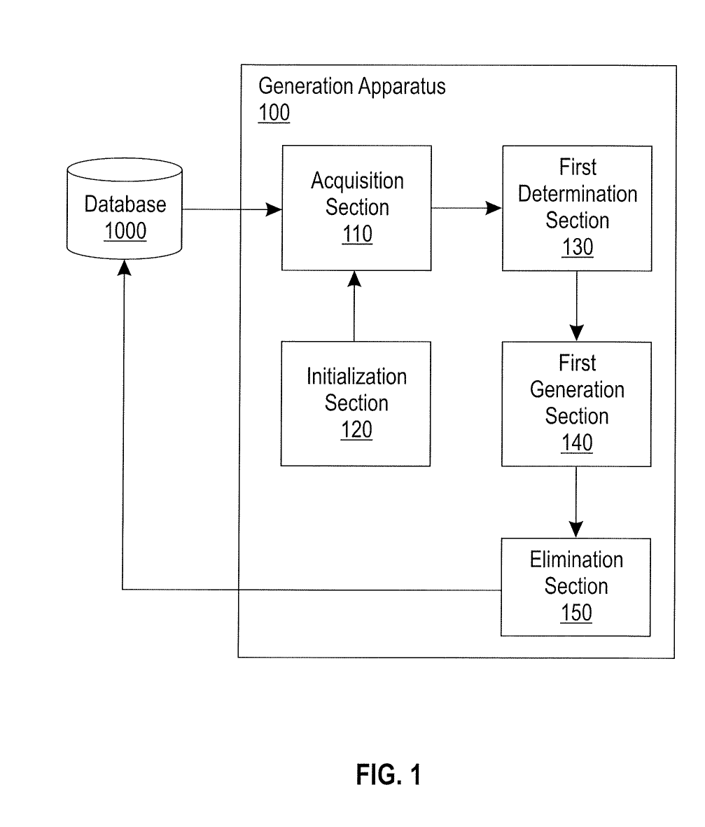

FIG. 1 shows an exemplary configuration of a generation apparatus 100 according to a present embodiment. The generation apparatus 100 generates gain vectors for calculating cumulative expected gains for a transition model in which a transition from a current state to the next state occurs in response to an action.

Here, the transition model is a model which models, for behaviors such as “a robot moves,” “recognize a voice and give a reply and information corresponding to the recognized voice,” and “consumers perform consumption activities, obtaining information about goods,” individual actions included in each behavior and multiple states among which the transition occurs by the action. Among the multiple states, one or more states may be hidden states that cannot be observed. In this case, it is possible to perform modeling by a partially observable Markov decision process (POMDP).

Even if a transition parameter, such as a state transition probability, has not been strictly determined, the generation apparatus 100 can generate gain vectors to calculate a decision making strategy that includes state transitions according to cumulative expected gains. The generation apparatus 100 can generate gain vectors at a target time point based on gain vectors at and after a next time point after the target time point. As an example, the generation apparatus 100 is provided with software that executes on a computer. The generation apparatus 100 includes an acquisition section 110, an initialization section 120, a first determination section 130, a first generation section 140 and an elimination section 150.

The acquisition section 110 acquires gain vectors at a next time point immediately after a target time point that include cumulative expected gains at and after the next time point for each state at the next time point. The acquisition section 110 acquires a set of gain vectors at the next time point that includes at least one gain vector. The acquisition section 110 may be connected to, for example, an external storage device such as a database 1000, and can acquire the gain vectors at the next time point from the database 1000. Further, the acquisition section 110 may be connected to a storage device inside the generation apparatus 100, and can acquire the gain vectors at the next time point from the internal storage device.

The initialization section 120 initializes gain vectors at a future time point. The initialization section 120 is connected to the acquisition section 110, and, prior to calculating gain vectors for the whole period targeted by the transition model, initializes a set of gain vectors at a predetermined future time point, such as the last time point of a period. For example, the initialization section 120 can initialize the gain vectors at a certain future time point to be a set of zero vectors. The initialization section 120 provides the initialized set of gain vectors to the first determination section 130.

The first determination section 130 determines the value of a transition parameter used for transitioning from the target time point to the next time point, from a valid range of the transition parameter, according to cumulative expected gains to be obtained from the gain vectors at the next time point. The first determination section 130 is connected to the acquisition section 110 and receives the initialized gain vectors and the gain vectors at the next time point. Here, the range that the transition parameter can take may be a user specified range. Alternatively, the range may be automatically calculated in advance. The user may store range information into a storage device such as the database 1000 via a network. In this case, the first determination section 130 can acquires the range information via the acquisition section 110.

When the acquisition section 110 acquires a set of gain vectors, the first determination section 130 determines a transition parameter value for each gain vector in the set at the next time point. A detailed method of determining transition parameters by the first determination section 130 will be described below. The first determination section 130 provides the determined transition parameters to the first generation section 140.

The first generation section 140 is connected to the first determination section 130 and generates gain vectors at the target time point from the gain vectors at the next time point, using the transition parameters. When the acquisition section 110 acquires a set of gain vectors, the first generation section 140 generates a gain vector at the target time point using the transition parameter determined for each gain vector in the set at the next time point, and adds the gain vector to the set at the target time point. The first generation section 140 provides the generated gain vectors to the elimination section 150.

The elimination section 150 is connected to the first generation section 140, and eliminates from the set of gain vectors at the target time point received from the first generation section 140 those gain vectors that are not maximum values within a probability distribution range of each state. The elimination section 150 prunes the generated set of gain vectors at the target time point. Here, if the number of elements in the set of gain vectors received from the first generation section 140 is less than a predetermined number, the elimination section 150 may not perform the elimination operation. Further, if it can be determined in advance that pruning is unnecessary, no elimination section 150 may be provided. The elimination section 150 is connected to the database 1000 and can store gain vectors in the database 1000.

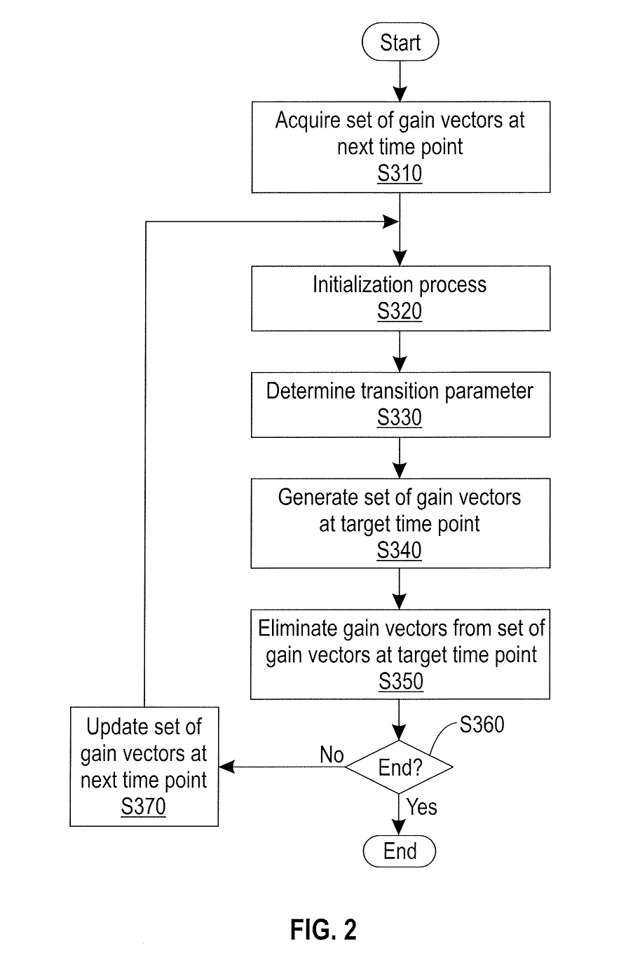

The generation apparatus 100 according to a present embodiment can generates gain vectors at a target time point based on gain vectors at the next time point. Then, the generation apparatus 100 updates the generated gain vectors at the target time point to be gain vectors at the next time point, causes a time point before the target time point to be a new target time point, and generates gain vectors at the new target time point. In this way, the generation apparatus 100 generates gain vectors at a target time point, going back from a future time point. Thus, the generation apparatus 100 can sequentially generate gain vectors for a whole period targeted by a transition model. A gain vector generation operation of the generation apparatus 100 will be described with reference to FIG. 2.

FIG. 2 is a flowchart of a method of operation of the generation apparatus 100 according to a present embodiment. In a present embodiment, the generation apparatus 100 executes process steps S310 to S360 to generate a set of gain vectors for calculating cumulative expected gains for the transition model in which a transition from the current state to the next state occurs in response to an action.

The acquisition section 110 acquires a set of gain vectors at the next time from the database 1000 or an internal storage device of the generation apparatus 100 (S310). Here, Λₙ represents a set of gain vectors αₙ at time point n, where n is an integer greater than or equal to 0.

Letting a target time point be denoted by n, the acquisition section 110 acquires a set Λₙ₊₁ of gain vectors αₙ₊₁ at the next time point n+1. Here, the gain vector αₙ has a plurality of components, each of which corresponds to a state. Each element for each state at time point n represents the cumulative expected gains when an action associated with αₙ is executed.

Further, the acquisition section 110 acquires information about a valid range of the transition parameter. Here, a probability that, when an action a, where a∈A; A is a set of actions, is executed in a state s, where s∈S; S is a set of states, the state s transitions to a state t, and a value z, where z∈Z; Z is a set of observations, is observed to be a state transition probability P(t,z|s,a), which is a transition parameter. That is, for each pair s∈S and a∈A, the acquisition section 110 acquires a valid range Pₛ^{a} for a state transition probability function P(•,•|s,a).

The initialization section 120 initializes a set Λ_{N} of gain vectors α_{N} at a future time point N in the transition model (S320). For example, the initialization section 120 initializes the set Λ_{N} of gain vectors α_{N} as a set of zero vectors {(0, . . . , 0)}, where the number of zeros is the same as the number of states (|S|).

The first determination section 130 determines a transition parameter value for the transition from target time point n to the next time point n+1 based on cumulative expected gains obtained from the set Λₙ₊₁ of gain vectors αₙ₊₁ at the next time point n+1. The first determination section 130 determines the state transition probability function P(•,•|s,a) for each pair s∈S and a∈A as a transition parameter from the valid range Pₛ^{a} of the state transition probability.

Here, the cumulative expected gains are the gains expected when an action is executed and state transition occurs. The expected gains may be calculated from a product of the state transition probability P(t,z|s,a) and gains obtained when an action a is executed in a state s. The first determination section 130 determines a transition parameter value for each gain vector αₙ₊₁ in the set Λₙ₊₁ of gain vectors.

For example, the first determination section 130 can determine a transition parameter value that minimizes the cumulative expected gains obtained from the set Λₙ₊₁ of gain vectors αₙ₊₁ at the next time point n+1. Further, the first determination section 130 can determine a transition parameter value that approximately minimizes the cumulative expected gains obtained from the set Λₙ₊₁ of gain vectors αₙ₊₁ at the next time point n+1. Alternatively, the first determination section 130 can determine a transition parameter value for which the cumulative expected gains are equal to or less than a predetermined reference value, the highest value, the mean value, a predetermined percentile value, etc., within the valid range Pₛ^{a} of the transition parameter.

The first generation section 140 generates the set Λₙ of gain vectors αₙ of the target time point n using the transition parameters (S340). In response to each of multiple actions a performed at the target time point n, the first generation section 140 generates gain vectors αₙ at the target time point n from the cumulative expected gains that are based on the transition parameter for each state s in response to an action a and the expected gains for each state s. For example, the first generation section 140 generates a gain vector αₙ for each multiple action a and adds the gain vector αₙ to the set Λₙ.

The first generation section 140 generates the set Λₙ of the gain vectors αₙ at the target time point n based on the set Λₙ₊₁ of gain vectors αₙ₊₁ at the next time point n−1.

The elimination section 150 eliminates a gain vector from the set Λₙ of gain vectors αₙ at the target time point that, for any probability vector π, does not maximize an inner product with the probability vector π, (S350). The elimination section 150 can store the set Λₙ of gain vectors αₙ into the database 1000. A specific elimination method of the elimination section 150 will be described below.

The generation apparatus 100 determines whether or not to continue generating the set Λₙ of gain vectors αₙ (S360). For example, the generation apparatus 100 determines whether or not n=0 is satisfied, and, if n=0 is satisfied, ends the process (S360: Yes). Further, if n=0 is not satisfied (S360: No), the generation apparatus 100 decrements n, and updates the set of gain vectors at the next time point from the set Λₙ of gain vectors αₙ(S370). After that, the generation apparatus 100 returns the process to S320. Thus, the generation apparatus 100 generates a set Λₙ of gain vectors αₙ.

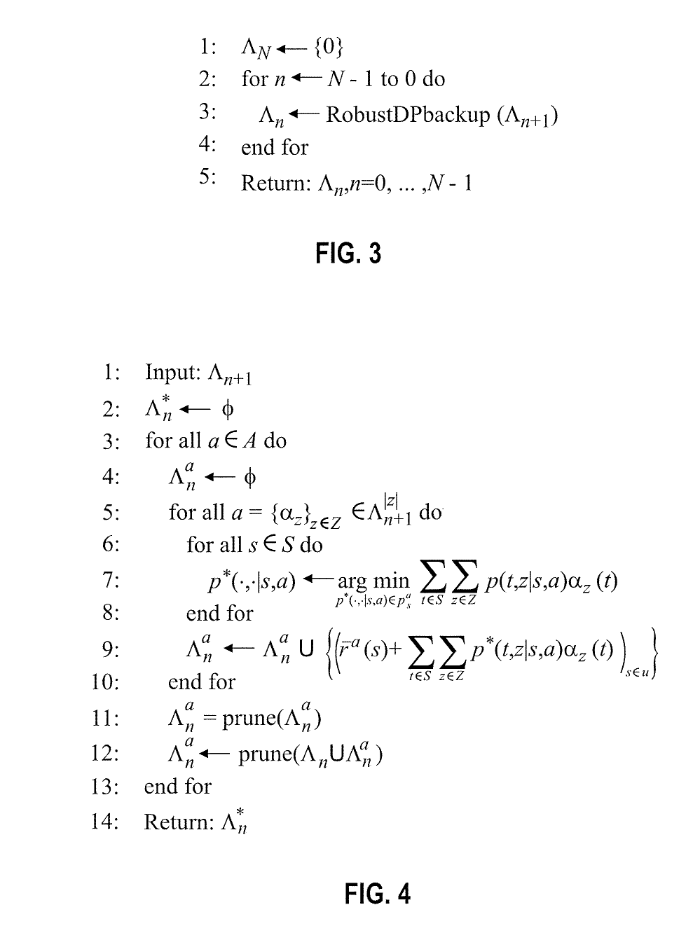

FIG. 3 shows an example of a specific algorithm of the operation in FIG. 2. Here, an exemplary algorithm of the generation apparatus 100 will be described with reference FIG. 3.

In line 1, the initialization section 120 initializes the set Λ_{N} of gain vectors α_{N} at the future time point N as a set {(0, . . . , 0)} of zero vectors.

As shown in line 2, the generation apparatus 100 begins a first loop defined by lines 2 to 4. As shown in line 3, the generation apparatus 100 generates the set Λₙ of gain vectors αₙ by a RobustDPbackup function within the first loop. That is, the generation apparatus 100 executes the process of line 3, beginning with N−1 as the target time point n, to generate sets Λₙ of gain vectors αₙ, and repeats the process N times until the target time point n becomes a time point 0.

The generation apparatus 100 increments the target time point n from 0 up to N−1 to sequentially output the generated sets Λₙ of gain vectors αₙ. Thus, the generation apparatus 100 traces the target time point n in a time series from the future time point N−1 to sequentially generate a set Λₙ of gain vectors αₙ corresponding to the target time point n. The RobustDPbackup function for generating the set Λₙ of gain vectors αₙ will be described with reference to FIG. 4.

FIG. 4 shows another example of a specific algorithm of the operation of FIG. 2. Here, an exemplary algorithm for generating the set Λₙ of gain vectors αₙ by the generation apparatus 100 will be described with reference to FIG. 4. That is, the algorithm shown in FIG. 4 is an example of the RobustDPbackup function.

In line 1, the first determination section 130 acquires the set Λₙ₊₁ of gain vectors at the time point n+1.

In line 2, the first determination section 130 initializes a set Λ*ₙ of gain vectors for all actions a at the time point n as an empty set.

In line 3, the first determination section 130 begins a first loop defined by lines 3 to 13 for each of the actions a.

In line 4, the first determination section 130 initializes within the first loops a set Λ^{a}ₙ of gain vectors α^{a}ₙ associated with actions a as an empty set.

In line 5, the first determination section 130 begins a second loop defined by the lines 5 to 10 within the first loop for all gain vector combinations that may overlap, for z gain vectors α_{z}, where z∈Z; Z is a set of observations, in the set Λₙ₊₁ of gain vectors.

In line 6, the first determination section 130 begins a third loop defined by lines 6 to 8 within the second loop for each state s (s∈S).

In line 7, the first determination section 130 determines a state transition probability function P*(•,•|s,a) from a valid range Pₛ^{a} (:=P(•,•|(s,a)) for the state transition probability function in each pair of s∈S and a∈A which minimizes the value of a predetermined formula. Here, for example, the predetermined formula is the cumulative expected gains obtained by calculating a sum total of products of the state transition probability P(t,z|s,a) and elements α_{z}(t) of gain vectors for the state t at the time point n+1 and an observed value z. That is, the first determination section 130 executes the third loop to determine a state transition probability function P(•,•|s,a) from the valid range Pₛ^{a} for the state transition probability function in each pair of s∈S and a∈A which minimizes the cumulative expected gains as the transition parameter P*(•,•|s,a).

In line 9, after the third loop within the second loop, the first generation section 140 generates gain vectors α^{a}ₙ for the actions a using the transition parameter P*(•,•|s,a) and adds the gain vectors α^{a}ₙ to the set Λ^{a}ₙ. For example, the first generation section 140 generates gain vectors α^{a}ₙ at the target time point n as a sum of cumulative expected gains for state transition from the transition parameter P* (•,•|s,a) and immediate expected gains F in the state s.

Here, the first term r̅^{a} in parentheses in line 9 represents the immediate expected gains when the action a is executed in the state s. The second term represents cumulative expected gains when action a is executed in state s, a transition to a state t occurs, and an amount z is observed. Then, the first generation section 140 updates the set Λ^{a}ₙ by a union of gain vectors α^{a}ₙ and the set Λ^{a}ₙ at the target time point n. In the above second loop, the state transition probability function P(•,•|s,a) that minimizes the cumulative expected gains is determined, that is, a probability value in the worst case is determined, for each combination of the z gain vectors α_{z} to generate the gain vectors α^{a}ₙ at the target time point n.

In line 11, the elimination section 150 may, after the second loop and within the first loop, prune the set Λ^{a}ₙ by providing the set Λ^{a}ₙ as an argument to a Prune function. Here, the Prune function eliminates, from the input set, those vectors from the argument vector set that do not maximize an inner product with at least one probability vector b.

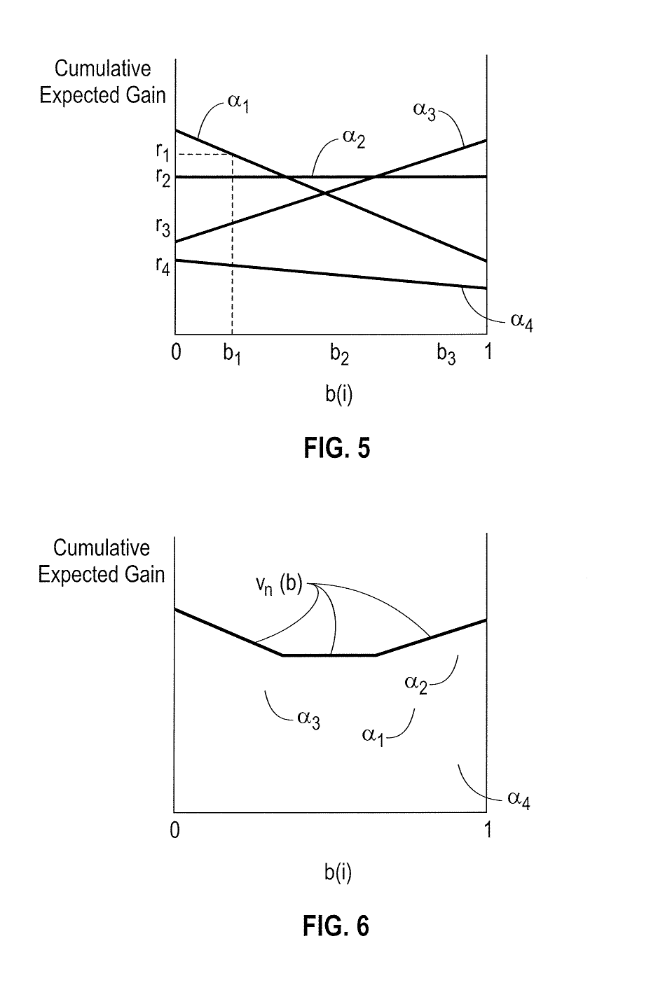

In addition, in line 12, the elimination section 150 updates the set Λ*ₙ within the first loop by providing a union of the set Λₙ and the set Λ^{a}ₙ to the Prune function. The Prune function will be described with reference to FIGS. 5 and 6.

FIG. 5 shows a relationship between the set Λₙ of gain vectors and cumulative expected gains according to a present embodiment. Here, a set Λₙ of gain vectors includes gain vectors α₁, α₂, α₃, and α₄. Each gain vector can be used to calculate the cumulative expected gains of a probability distribution b of each state s. For convenience of description, FIG. 5 will be described on the assumption that each gain vector returns the value of cumulative expected gains according to only a value b(i) of a probability of being in a single state i. Here, the probability value b(i) is in the closed interval [0,1].

For example, when the probability value b(i) of being in the state i is b₁, the gain vector α₁ corresponding to b₁ returns cumulative expected gains r₁, the gain vector α₂ corresponding to b₁ returns cumulative expected gains r₂, the gain vector α₃ corresponding to b₁ returns cumulative expected gains r₃, and the gain vectors α₄ corresponding to b₁ returns cumulative expected gains r₄.

Since the cumulative expected gains r₁ is the maximum of cumulative expected gains r₁ to r₄ as shown in FIG. 5, the gain vector α₁ corresponding to the cumulative expected gains r₁ can be selected from the set of gain vectors α₁ to α₄. Similarly, the gain vector α₂ that has the maximum cumulative expected gain value for the probability value b₂ is selected, and the gain vector α₃ that has the maximum cumulative expected gain value for the probability value b₃ is selected.

Here, when executing decision making in accordance with an optimum strategy, a gain vector that maximizes cumulative expected gains is selected. This will be described below. That is, it is clear that, among the set of the gain vectors α₁ to α₄, the gain vector α₄ that does not maximize the cumulative expected gain value for any probability value b(i) is an unnecessary gain vector that is not selected. Therefore, the elimination section 150 deletes such an unnecessary gain vector. That is, the elimination section 150 calculates cumulative expected gains using each of multiple values that the probability value b(i) can take, and identifies and deletes any gain vector that does not maximize any cumulative expected gain value. Thus, the elimination section 150 can prune meaningless gain vectors to improve calculation efficiency.

FIG. 6 shows a gain function that returns a maximum value of cumulative expected gains according to a present embodiment, the gain function being obtained by connecting gain vector parts that take the maximum value. As shown in FIG. 6, by connecting only sections where cumulative expected gains take the maximum value for the multiple gain vectors α₁ to α₄, a gain function vₙ(b), which is a piecewise-linear convex function facing downward, is obtained as indicated by a thick line. The gain function vₙ(b) depends on the probability distribution b, which can be represented by vₙ(b)=max[Σᵢb(i)α(i)].

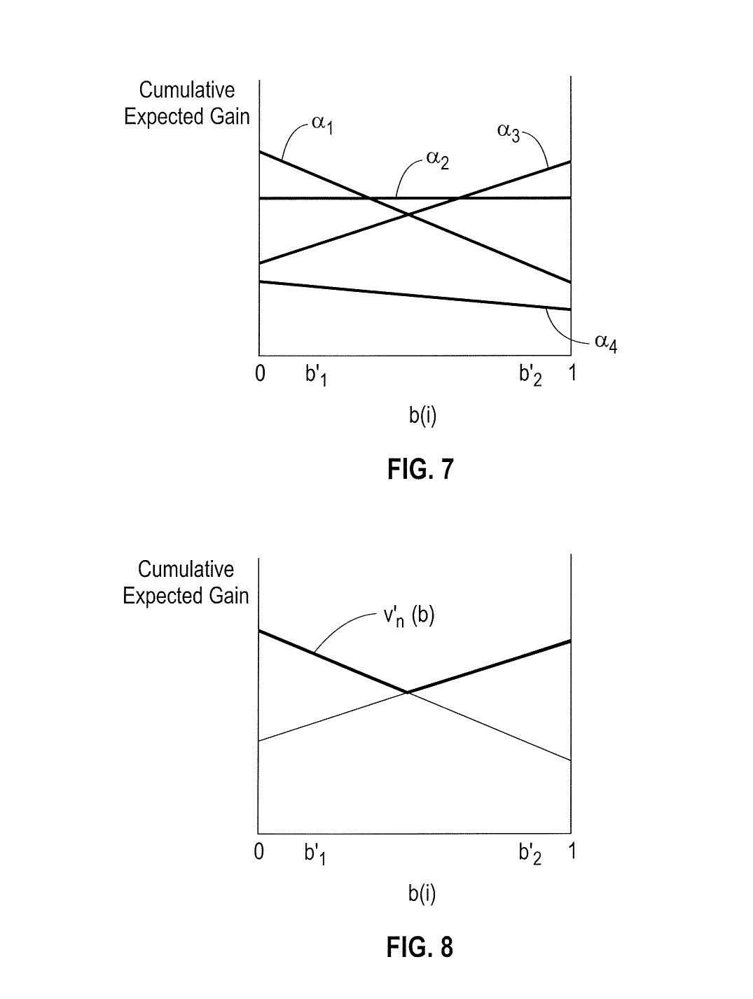

FIG. 7 shows a modification of a relationship between the set Λₙ of gain vectors and the cumulative expected gains according to a present embodiment. FIG. 7 illustrates an example of the first generation section 140 generating the set Λₙ of gain vectors that includes gain vectors α₁, α₂, α₃, and α₄ similar to FIG. 5.

In a present modification, the elimination section 150 selects probability distributions b1′ and b2′. For convenience of description, FIG. 7 will be described on the assumption that the selected probability distributions b1′ and b2′ are not vectors but probability values b(i) corresponding to a single state i.

For example, the elimination section 150 selects the gain vector α₁ that maximizes a value of cumulative expected gains for the probability distribution b1′. Further, the elimination section 150 selects the gain vector α₃ that maximizes a value of cumulative expected gains for the probability distribution b2′ . Thus, the elimination section 150 eliminates from the set Λₙ of gain vectors αₙ at a target time point those gain vectors that do not maximize the value of cumulative expected gains in predetermined probability distribution within the probability distribution range of each state.

Here, the predetermined probability distribution for selection may be stored in advance into a storage device such as the database 1000. As described above, the elimination section 150 can eliminate unnecessary gain vectors by using probability.

FIG. 8 shows a gain function that returns a maximum value of the cumulative expected gains corresponding to the modification in FIG. 7. FIG. 8 shows a gain function obtained by connecting gain vector parts that take the maximum values, similar to FIG. 6. As shown in FIG. 8, by connecting those sections of the gain vectors α₁ to α₃ where cumulative expected gains take the maximum value, a downward facing piecewise-linear convex gain function vₙ(b), indicated by a thick line, is obtained. Letting α be the gain vectors included in the set Λₙ of gain vectors, a gain function vₙ(b) depending on the probability distribution b may be represented by vₙ(b)=max[Σᵢb(i)α(i)].

As described above, the generation apparatus 100 in a present embodiment updates the set Λ*ₙ and repeats the first loop of FIG. 4 for all actions a. Thus, the generation apparatus 100 can generate the set Λₙ of gain vectors αₙ, and the generation apparatus 100 returns the generated set Λ*ₙ and terminates the algorithm in line 14 of FIG. 4.

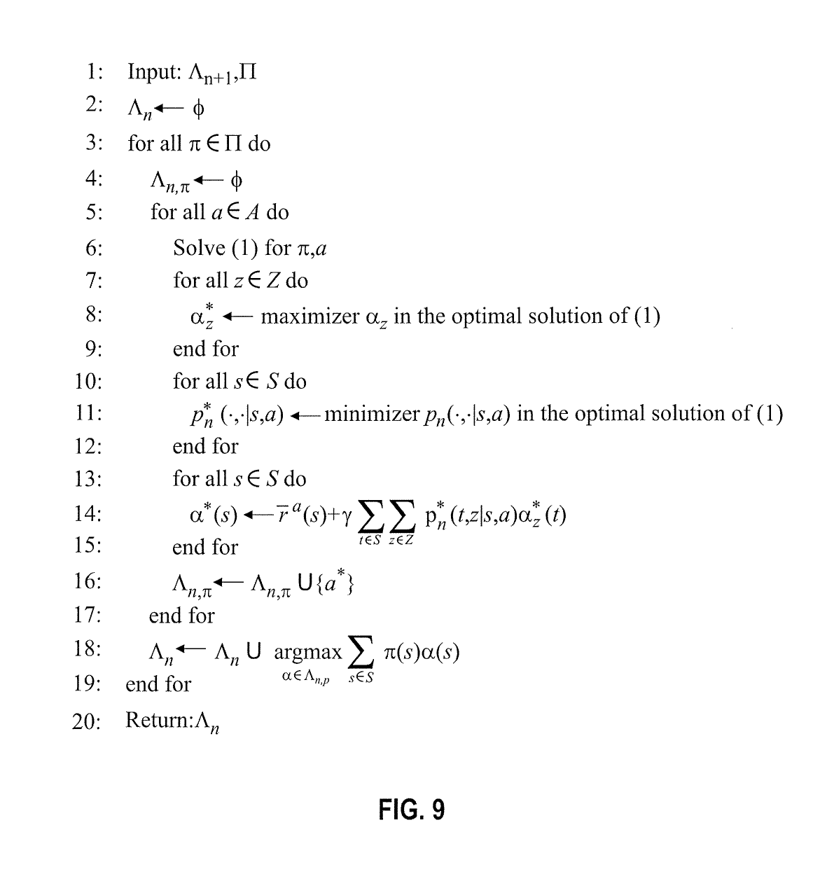

In the above algorithm shown in FIG. 4, an example has been described of determining a state transition probability function in the worst case for all overlapping combinations of z gain vectors α_{z} in the set Λₙ₊₁ of gain vectors, and generating the set Λₙ of gain vectors αₙ. Alternatively, the generation apparatus 100 may generate the set Λₙ of gain vectors αₙ by solving a convex optimization task in which the valid range Pₛ^{a} (:=P(•,•|s,a)) of the state transition probability for each pair s∈S and a∈A is assumed to be a convex set. A function for solving the convex optimization task and generating the set Λₙ of gain vectors αₙ will be described with reference to FIG. 9.

FIG. 9 shows another example of a specific algorithm of the operation of FIG. 2. That is, the algorithm shown in FIG. 9 is an example of a point-based RobustDPbackup function.

In line 1, the first determination section 130 acquires the set Λₙ₊₁ of gain vectors at the time point n+1 and a set Π of assumed probability vectors π. Here, the assumed probability vector π includes an assumed probability π(s) as a component, and the assumed probability π(s) is a probability distribution for selection as described in FIGS. 5 to 8. Further, the assumed probability π(s) may be a probability of a user assuming (believing) that the state is s. The set Π of the assumed probability vectors π may be stored in advance in a database, and the first determination section 130 may acquire the set Π of the assumed probability vectors π via the acquisition section 110.

In line 2, the first determination section 130 initializes the set Λₙ of gain vectors as an empty set.

In line 3, the first determination section 130 begins a first loop defined by lines 3 to 19 for each of the assumed probability vectors π (π∈Π).

In line 4, within the first loop, the first determination section 130 initializes a set Λ_{n,π} of gain vectors αₙ associated with the assumed probability vectors π as an empty set.

In line 5, within the first loop, the first determination section 130 begins a second loop defined by the lines 5 to 17 for each action a (a∈A).

In line 6, the first determination section 130 solves a convex optimization task of minimizing a sum total of an objective function U(z) expressed by Equation 1. Note that (1) in line 6 refers to Equation 1.

$$\begin{matrix}\begin{matrix}min . & {\sum }_{z ∈ Z} U ( z )\end{matrix} \\ \begin{matrix}s . t . & U ( z ) \geq {\sum }_{s ∈ S} π ( s ) {\sum }_{t ∈ S}^{ } {p}_{n} ( t , z \vert s , a ) {α}_{z} ( t ) , ∀ {α}_{z} ∈ {Λ}_{n + 1} , ∀ z ∈ Z\end{matrix} & [ Formula 1 ] \\ {p}_{n} ( \cdot , \cdot \vert s , a ) ∈ {P}_{s}^{a} , ∀ s ∈ S . & \end{matrix}$$

The first determination section 130 can efficiently solve the convex optimization task using a known method by assuming, for each s and each a, the range of the state transition probability function P(•,•|s,a) to be a convex set Pₛ^{a}.

In line 7, the first determination section 130 begins a third loop within the second loop defined by lines 7 to 9 for each of observed values z (z∈Z).

In line 8, the first determination section 130 obtains a gain vector α*_{z} from gain vectors α_{z} that maximizes the objective function U(z by solving Formula 1. That is, the gain vector α*_{z} changes the inequality sign in Formula 1 to an equality sign. The first determination section 130 may store gain vector α*_{z} in the process of solving Formula 1.

In line 10, after the third loop, the first determination section 130 begins a fourth loop within the second loop defined by lines 10 to 12 for each of states s (s∈S).

In line 11, the first determination section 130 obtains a state transition probability function Pₙ*( , |s,a) from the state transition probability functions P(•,•|s,a) that maximizes the objective function U(z), by solving Formula 1. That is, the state transition probability function P*(•,•|s,a) is an optimum solution of Formula 1. That is, the first determination section 130 causes this state transition probability function P*(•,•|s,a) to be the transition parameter used for the transition from the time point n to the next time point n+1. The first determination section 130 may store state transition probability function P*(•,•|s,a) in the process of solving Formula 1.

In line 13, after the fourth loop, the first generation section 140 begins a fifth loop within the second loop defined by lines 13 to 15 for each state s (s∈S)

In line 14, the first generation section 140 generates gain vectors α*ₙ using the transition parameter P*(•,•|s,a). For example, the first generation section 140 generates gain vectors α*ₙ at the target time point n that are a sum of cumulative expected gains calculated by the transition parameter P*(•,•|s,a) and immediate expected gains r̅^{a} (s) based on the state s.

The first term r̅^{a} (s) in line 14 represents the immediate expected gains obtained when an action a is executed in a state s. The second term represents the cumulative expected gains obtained when the action a is executed in the state s, a transition to a state t occurs, and an amount z is observed. Here, for the cumulative expected gains of the second term, an example of being multiplied by a coefficient γ is shown. The coefficient γ is a discount rate having a value in the interval (0,1], and is a coefficient indicating how gains to be obtained in the future are to be weighted.

For example, the discount rate γ can be set so that, when a discount by γ is performed at one time point ahead, then discount by γ squared is performed at two time points ahead, and discount by γ to the power of n is performed at n time points ahead. Such a discount rate γ is not limited to being applied to the algorithm shown in FIG. 9 but may be applied to the algorithm shown in FIG. 4, such as to the second term in line 9.

In line 16, after the fifth loop, the first generation section 140 updates the set Λ_{n,π} within the second loop by a union of the generated gain vectors α*ₙ at the target time point n and the set Λ_{n,π}. As described above, the second loop is executed for each π sequentially, solves the convex plan task for all actions a, and s updates the set Λ_{n,π}. Therefore, there may be a case where multiple gain vectors α*ₙ are updated for one π.

In line 18, after the second loop, the first generation section 140 selects one gain vector αₙ for one π and updates the set Λₙ of gain vectors αₙ. That is, the first generation section 140 selects a gain vector αₙ of the gain vectors α*ₙ (α*ₙ∈Λ_{n,π}) generated by the second loop process that maximizes the sum of product of π(s) and α(s) for the state s (s∈S, and adds the gain vectors αₙ to the set Λₙ.

As described above, the first loop selects one gain vector αₙ for each π and adds the gain vector αₙ to the set Λₙ, and the first loops is repeated for the number of times corresponding to π. Thus, the generation apparatus 100 can keep the number of gain vectors αₙ included in the set Λₙ to be less than or equal to the number of π. As described above, the algorithm shown in FIG. 9 repeats the first loop to update the set Λₙ and generates a set Λₙ of gain vectors αₙ. Then, as shown in line 20, the generated set Λₙ is returned, and the algorithm terminates.

The algorithm shown in FIG. 9 has been described as determining the state transition probability P(t,z|s,a) by representing the assumed range Pₛ^{a} of the state transition probability function P(•,•|s,a) with the convex set expressed by Formula 1, and generating the gain vectors αₙ at the target time point n. In this case, by using a predetermined value P⁰ (t,z|s,a) as a reference value of the state transition probability P(t,z|s,a) and scaling an assumed range of the state transition probability P(t,z|s,a) up to 1/κ times (0<K<1) as large as the reference value, it is possible to transfrom the convex plan task of Formula 1 into a linear programming task as expressed by the next formula.

$$\begin{matrix}\begin{matrix}min . & {\sum }_{z ∈ Z} U ( z )\end{matrix} \\ \begin{matrix}s . t . & U ( z ) \geq {\sum }_{s ∈ S} π ( s ) {\sum }_{t ∈ S}^{ } {p}_{n} ( t , z \vert s , a ) {α}_{z} ( t ) , ∀ {α}_{z} ∈ {Λ}_{n + 1} , ∀ z ∈ Z\end{matrix} & [ Formula 2 ] \\ 0 \leq {p}_{n} ( t , z \vert s , a ) \leq \frac{1}{k} {p}_{n}^{∘} ( t , z \vert s , a ) , ∀ s , t ∈ S , z ∈ Z \\ {\sum }_{t , z} {p}_{n} ( t , z \vert s , a ) = 1 , ∀ s ∈ S & \end{matrix}$$

In Formula 2, although the range of the state transition probability P(t,z|s,a) is assumed to be 1/k times as large as the reference value, the central value or the variance, etc., of the reference value may be used instead. Thus, the first determination section 130 may determine the state transition probability from a range that is up to a constant multiple of the reference value P⁰ (t,z|s,a) of state transition probability as a valid range for the state transition probability P(t,z|s,a). In this case, the first determination section 130 may solve Formula 2 instead of Formula 1 in line 6 of the algorithm shown in FIG. 9.

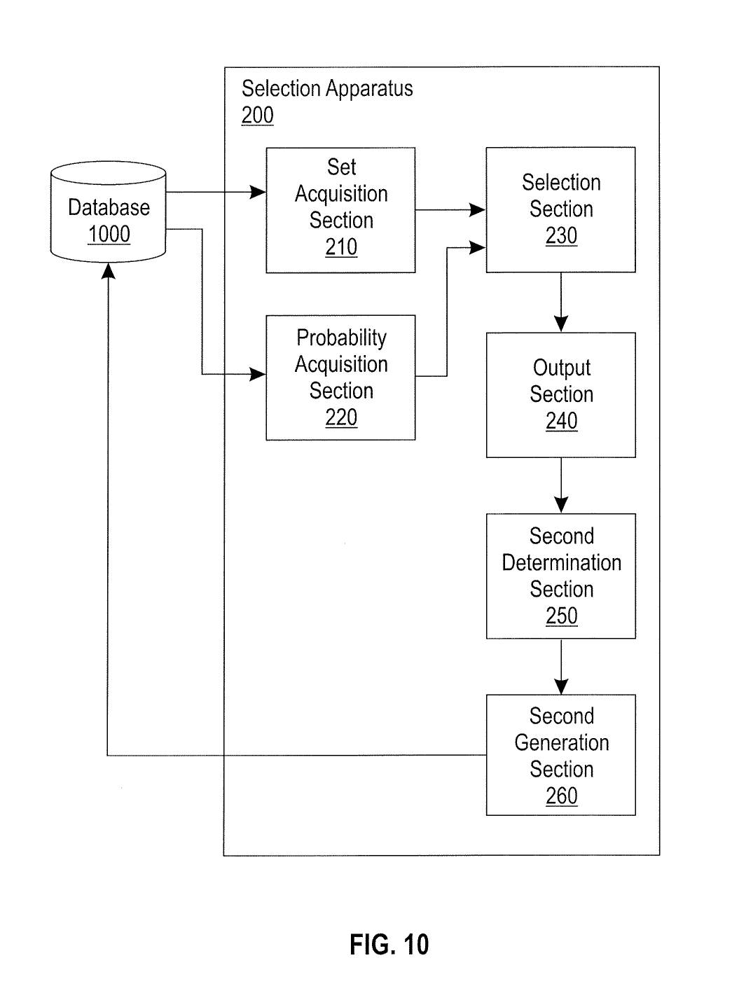

As described above, the generation apparatus 100 of a present embodiment can determine a transition parameter value in the worst case from a valid range of transition parameter values that minimizes the cumulative expected gains obtained from the gain vectors at the next time point, and can generate gain vectors at a target time point. By using gain vectors generated in this way, it is possible to calculate an optimum decision making strategy that guarantees a certain level of performance. A selection apparatus for selecting an appropriate action to be executed as the optimum decision making strategy will be described with reference to FIG. 10.

FIG. 10 shows an exemplary configuration of a selection apparatus 200 according to a present embodiment. The selection apparatus 200 can select an action a based on a set of gain vectors in a transition model in which a transition from the current state to the next state occurs in response to the action a. The selection apparatus 200 is provided with a set acquisition section 210, a probability acquisition section 220, a selection section 230, an output section 240, a second determination section 250, and a second generation section 260.

The set acquisition section 210 acquires a set Λₙ of gain vectors αₙ for a target time point n that include cumulative expected gains obtained for and after the target time point n for each state at the target time point n. The set acquisition section 210 is connected, for example, to an external storage device such as the database 1000, and it acquires the set Λₙ of gain vectors αₙ for the target time point n. Further, the set acquisition section 210 may be connected to an internal storage device of the generation apparatus 100 and may acquire the set Λₙ of gain vectors αₙ for the target time point n. A non-limiting example will be described in which the set acquisition section 210 of a present embodiment acquires the set Λₙ of gain vectors αₙ for the target time point n generated by the generation apparatus 100.

The probability acquisition section 220 acquires an assumed probability vector π for each state s at the target time point n. The probability acquisition section 220 may be connected to an external storage device such as the database 1000 and may acquire the assumed probability vector π similar to the set acquisition section 210.

The selection section 230 selects a gain vector α*ₙ from the set Λₙ of gain vectors αₙ based on the set Λₙ of gain vectors αₙ and the assumed probability vector π. The selection section 230 is connected to the set acquisition section 210 and the probability acquisition section 220 and receives the set Λₙ of gain vectors αₙ and the assumed probability vector π therefrom.

The output section 240 selects and outputs an action a corresponding to the selected gain vector α*ₙ. The output section 240 is connected to the selection section 230 and receives the selected gain vector α*ₙ therefrom. The output section 240 may receive an action a used when the generation apparatus 100 generated the selected gain vector α*ₙ as the corresponding action a, from the set acquisition section 210 via the selection section 230. In this case, the set acquisition section 210 acquires an action a corresponding to each gain vector αₙ. The output section 240 may output an action a to be executed.

The second determination section 250 determines a transition parameter value used for the transition from the target time point n to the next time point n+1, from a valid range of the transition parameter. The second determination section 250 may be connected to the output section 240 and determines a transition parameter value for which cumulative expected gains obtained from the selected gain vector α*ₙ become less than or equal to a predetermined reference. Further, the second determination section 250 determines a transition parameter value which minimize the cumulative expected gains obtained with the use of the selected gain vectors α*ₙ.

The second generation section 260 generates an assumed probability π(t) for each state t at the next time point using the transition parameter. The second generation section 260 is connected to the second determination section 250 and generates an assumed probability vector π at the next time point n+1 using the received transition parameter value and information about the set Λₙ₊₁ of gain vectors αₙ₊₁ at the next time point. The second generation section 260 is connected to an external storage device such as the database 1000 and stores the generated assumed probability vector π.

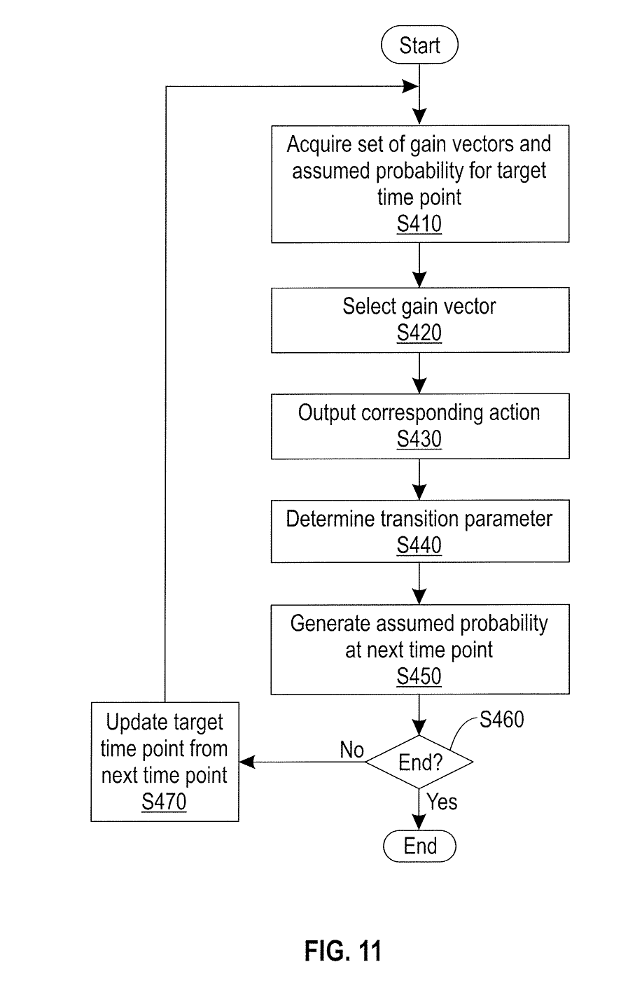

The above selection apparatus 200 according to a present embodiment sequentially executes the actions a in time series, for example, from a time point n=0 toward a future time point N, where N>n, to update the assumed probability vector π and execute a decision making strategy. The execution of a decision making strategy by the selection apparatus 200 will be described with the use of FIG. 11.

FIG. 11 shows an operation of the selection apparatus 200 according to a present embodiment. The selection apparatus 200 selects an action a to be executed based on the set Λₙ of gain vectors αₙ by executing the process from S410 to S470.

The set acquisition section 210 acquires the set Λₙ of gain vectors αₙ (S410). The set acquisition section 210 may acquire the set Λₙ together with each action a corresponding to each gain vector αₙ in the set Λₙ. Letting the first time point in a period during which a decision making strategy is executed be the target time point n, the set acquisition section 210 acquires the set Λₙ of gain vectors αₙ for the target time point n. A non-limiting example will be described in which the set acquisition section 210 according to the present embodiment uses n=0 as a target time point. Further, the set acquisition section 210 may acquire the set Λₙ₊₁ of gain vectors αₙ₊₁ for the next time point n+1. Alternatively, the set acquisition section 210 may acquire a set of gain vectors for a period during which the decision making strategy is executed.

Further, the probability acquisition section 220 acquires the assumed probability vector π. An assumed probability vector for the initial time point n (=0) may be determined by a user in advance.

The selection section 230 selects one gain vector α*ₙ from the set Λₙ of gain vectors αₙ for the target time point n (S420). The selection section 230 selects such a gain vector α*ₙ that maximizes an inner product of an assumed probability vector πₙ with the gain vectors αₙ, where αₙ∈Λₙ, as expressed in the following Formula.

$${α}^{*} \text{:} = arg {max}_{α ∈ {Λ}_{n}} α \cdot {π}_{n} \qquad [ Formula 3 ]$$

The output section 240 outputs an action a corresponding to the selected gain vectors α*ₙ (S430). The output section 240 may output the corresponding action a and execute action a. The output section 240 obtains an observed value z from the execution of action a.

The second determination section 250 determines a transition parameter value for the transition from the target time point n to the next time point n+1 (S440). The second determination section 250 determines the transition parameter value using the assumed probability vector π, the corresponding action a, the observed value z and the set Λₙ₊₁ of gain vectors αₙ₊₁ for the next time point n+1. For example, the second determination section 250 determines the transition parameter value using the following formula.

$${\tilde{p}}_{n} ( \cdot , \cdot \vert \cdot , a ) \text{:} = arg {min}_{p ∈ {P}^{a}} {\sum }_{z ∈ Z}^{ } {max}_{{α}_{z} ∈ {Λ}_{n + 1}} {\sum }_{s ∈ S} π ( s ) ( \frac{{\overline{r}}^{a} ( s )}{\vert Z \vert} + {\sum }_{t ∈ S} p ( t , z \vert s , a ) {α}_{z} ( t ) ) \qquad [ Formula 4 ]$$

The second determination section 250 calculates a state transition probability function that minimizes, at the time of transitioning from the target time point n to the next time point n+1, the cumulative expected gains, i.e., the worst case, and maximizes an inner product of the cumulative expected gains and the assumed probability vector π, within an assumed range P^{a} of P(•,•|•,a). Here, that P(•,•|•,a) is within the range of P^{a} means that, for all s′s, the state transition probability function P(•,•|s,a) is within a range of Pₛ^{a}. Thus, by acquiring sets of gain vectors generated by the generation apparatus 100 for a target time point n and the next time point n+1, the second determination section 250 can calculate, using the set of gain vectors, the worst case probability when transitioning from the target time point n to the next time point n+1.

The second generation section 260 uses the probability calculated by Formula 4 in the following formula to calculate an assumed probability πₙ₊₁(t) for the next time point n+1 for each t (S450). The second generation section 260 stores the calculated assumed probability vector πₙ₊₁ in a storage device and updates.

$${π}_{n + 1} ( t ) \text{:} = \frac{{\sum }_{s ∈ S} {\tilde{p}}_{n} ( t , z \vert s , a ) {π}_{n} ( s )}{{\sum }_{{s}^{′} , {t}^{′} ∈ S} {\tilde{p}}_{n} ( {t}^{′} , z \vert {s}^{′} , a ) {π}_{n} ( {s}^{′} )} , ∀ t ∈ S \qquad [ Formula 5 ]$$

Next, the second generation section 260 determines whether or not to end selection of an action a (S460). For example, the second generation section 260 continues selecting actions a until the last time point N of the period targeted by the transition model becomes the target time point n (S460: No). In this case, the second generation section 260 u the target time point n from the next time point (S470), returns to step S410, and selects an action a to continue. At step S410, the probability acquisition section 220 acquires an assumed probability vector πₙ₊₁ at the next time point n+1 updated by the second generation section 260.

Until a future time point N (N>n) becomes the target time point, the selection apparatus 200 continues sequential selection of actions a and update of the assumed probability vector in A time series to calculate a decision making strategy. When the future time point N becomes the target time point, the second generation section 260 ends selection of an action a (S460: Yes).

As described above, the selection apparatus 200 according to A present embodiment calculates an action a to be executed and an assumed probability vector πₙ₊₁ for the next time point based on a set of gain vectors and an assumed probability vector π generated by the generation apparatus 100. Then, the selection apparatus 200 can repeat selecting an action a to be executed next and updating of an assumed probability vector at the next time point based on a set of gain vectors and a calculated assumed probability vector πₙ₊₁ generated by the generation apparatus 100 to sequentially calculate decision making strategies in a time series during the period targeted by the transition model.

The generation apparatus 100 according to a present embodiment can determine a state transition probability function in the worst case from a valid range of the state transition probability function and can generate a set of gain vectors. Then, the selection apparatus 200 calculates a decision making strategy that maximizes cumulative expected gains in the worst case, based on the generated set of gain vectors. That is, when the transition parameter of the transition model is within a predetermined range, the generation apparatus 100 and the selection apparatus 200 according to a present embodiment can obtain cumulative expected gains in the worst case within the range. Therefore, the generation apparatus 100 and the selection apparatus 200 can estimate a range of the transition parameter that enables calculation of a realistic optimum decision making strategy even if the transition parameter of the transition model cannot be accurately estimated.

In a present embodiment, an example has been described in which the generation apparatus 100 and the selection apparatus 200 function separately and independently. Alternatively, the generation apparatus 100 and the selection apparatus 200 may be provided as one apparatus. For example, the selection apparatus 200 may be provided with the generation apparatus 100, and the set acquisition section 210 may acquire a set of gain vectors generated by the generation apparatus 100.

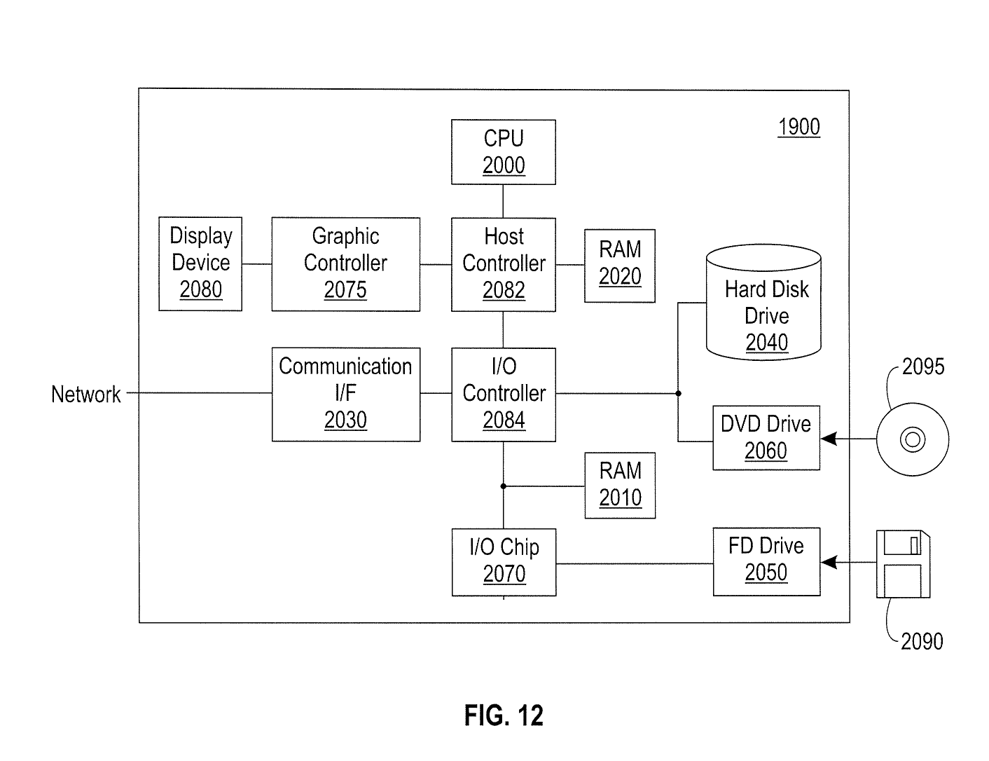

FIG. 12 shows an example of a hardware configuration of a computer 1900 that functions as the generation apparatus 100 and the selection apparatus 200 according to a present embodiment. The computer 1900 according to a present embodiment is provided with a CPU 2000, a RAM 2020, a graphic controller 2075, and a display device 2080 that are mutually connected via a host controller 2082, a communication interface 2030, a hard disk drive 2040, and a DVD drive 2060 that are connected to the host controller 2082 via an input/output controller 2084, and a legacy input/output section that includes a ROM 2010, a flexible disk drive 2050, and an input/output chip 2070 connected to the input/output controller 2084.

The host controller 2082 connects the RAM 2020 to the CPU 2000 and the graphic controller 2075 that access the RAM 2020 at a high transfer rate. The CPU 2000 operates based on programs stored in the ROM 2010 and the RAM 2020 and performs control of each section. The graphic controller 2075 acquires image data that the CPU 2000 generates in a frame buffer provided in the RAM 2020 and displays the image data on the display device 2080. Alternatively, the graphic controller 2075 may internally include the frame buffer for storing image data generated by the CPU 2000.

The input/output controller 2084 connects the host controller 2082 to the communication interface 2030, the hard disk drive 2040 and the DVD drive 2060, which are relatively high speed input/output devices. The communication interface 2030 can communicate with other apparatuses via a network. The hard disk drive 2040 stores programs and data used by the CPU 2000 in the computer 1900. The DVD drive 2060 can read a program or data from a DVD-ROM 2095 and can provide it to the hard disk drive 2040 via the RAM 2020.

The ROM 2010 and relatively low speed input/output devices, such as the flexible disk drive 2050 and the input/output chip 2070, are connected to the input/output controller 2084. The ROM 2010 stores a boot program that the computer 1900 executes at a starting time and/or programs dependent on the hardware of the computer 1900. The flexible disk drive 2050 can read a program or data from a flexible disk 2090 and can provide it to the hard disk drive 2040 via the RAM 2020. The input/output chip 2070 connects the flexible disk drive 2050 to the input/output controller 2084, and connects various input/output devices to the input/output controller 2084, for example, via a parallel port, a serial port, a keyboard port or a mouse port.

The program provided to the hard disk drive 2040 via the RAM 2020 can be stored in a recording medium such as the flexible disk 2090, the DVD-ROM 2095 or an IC card, and may be provided by the user. The program can be read from the recording medium, installed into the hard disk drive 2040 in the computer 1900 via the RAM 2020, and executed by the CPU 2000.

The program can be installed into the computer 1900 to cause the computer 1900 to function as the acquisition section 110, the initialization section 120, the first determination section 130, the first generation section 140, the elimination section 150, the set acquisition section 210, the probability acquisition section 220, the selection section 230, the output section 240, the second determination section 250 and the second generation section 260.

By being read into the computer 1900, information processing described in the program can function as the acquisition section 110, the initialization section 120, the first determination section 130, the first generation section 140, the elimination section 150, the set acquisition section 210, the probability acquisition section 220, the selection section 230, the output section 240, the second determination section 250, and the second generation section 260 that are provided by cooperation between software and the various hardware resources described above. Then, by providing operation and information processing by use of the computer 1900, a specific generation apparatus 100 and a specific selection apparatus 200 according to an embodiment of the disclosure may be configured.

For example, when communicating between the computer 1900 and an external apparatus, the CPU 2000 executes a communication program loaded on the RAM 2020, and instructs the communication interface 2030 to perform communication processing based on the processing content described in the communication program. In response to control by the CPU 2000, the communication interface 2030 reads out transmit data stored in a transmit buffer area provided on a storage device, such as the RAM 2020, the hard disk drive 2040, the flexible disk 2090 and the DVD-ROM 2095, and transmits the transmit data to a network, or writes receive data received from the network into a receive buffer area provided on the storage device. Thus, the communication interface 2030 may transmit/receive data to/from the storage device by a DMA (direct memory access) system. Alternatively, the CPU 2000 may transmit/receive data by reading out data from a transfer source storage device or communication interface 2030 and writing the data into a transfer destination communication interface 2030 or storage device.

Further, the CPU 2000 can cause all or a necessary part of a file, database, etc., stored in an external storage device, such as the hard disk drive 2040, the DVD-ROM 2095, and the flexible disk 2090, to be read into the RAM 2020 by DMA transfer and can perform various processing for the data on the RAM 2020. Then, the CPU 2000 can writes back the processed data to the external storage device by DMA transfer. In such a process, the RAM 2020 can temporarily hold the content of the external storage device, the RAM 2020, the external storage devices, etc., that are generically referred to as a memory, a storage section, a storage device, etc in an embodiment. Various information such as programs, data, tables, databases, etc., in a present embodiment can be stored in such a storage device and targeted by the information processing. The CPU 2000 can hold a part of the content of the RAM 2020 in a cache memory and perform reading and writing on the cache memory. In such a form, the cache memory performs part of the function of the RAM 2020. Therefore, it is assumed that the cache memory is also included among the RAM 2020, the memory and/or the storage device unless otherwise shown.

Further, the CPU 2000 can perform various processing specified by instructions, including various operations, information processing, conditional statements, information search/substitution, etc., described in a present embodiment, for data read out from the RAM 2020, and writes back the data to the RAM 2020. For example, when performing a conditional statement, the CPU 2000 determines whether various variables in a present embodiment are larger, smaller, equal or larger, equal or smaller, equal, etc., when compared with another variable or constant, and, if the condition is satisfied, or if the condition is not satisfied, branches to a different instruction or calls a subroutine.

Further, the CPU 2000 can search for information stored in a file or a database in the storage device. For example, when multiple entries in which attribute values of a second attribute is associated with attribute values of a first attribute, respectively, are stored in the storage device, the CPU 2000 can obtain an attribute value of the second attribute associated with the first attribute, which satisfies a predetermined condition, by searching for an entry in which the attribute value of the first attribute satisfies the specified condition from among the multiple entries stored in the storage device, and can read out the attribute value of the second attribute stored in the entry.

The program or module shown above may be stored in an external storage medium. Examples of storage media include a DVD, a Blu-ray Disc®, an optical recording medium such as a CD, a magneto-optic recording medium such as an MO, a tape medium, a semiconductor memory such as an IC card, etc., in addition to the flexible disk 2090 and the DVD-ROM 2095. It is also possible to use a storage device such as a hard disk and a RAM provided in a server system connected to a dedicated communication network or the Internet as a recording medium to provide the program to the computer 1900 via the network.

Exemplary embodiments of the present disclosure have been described with reference to the accompanying drawing figures. However, the technical scope of embodiments of the present disclosure is not limited to the range described in the above exemplary embodiments. It is apparent to those skilled in the art that various modifications or improvements can be made to exemplary embodiments described above. It is apparent from the description that such modified or improved embodiments can be included in the technical scope of the present disclosure.

What is claimed is:

1. A generation apparatus for generating gain vectors for a transition model, the apparatus comprising:
an acquisition section that acquires gain vectors for a next time point after a target time point, said gain vectors including a cumulative expected gains obtained at and after the next time point for each state at the next time point;
a first determination section that determines a value of a transition parameter used for transitioning from the target time point to the next time point, from a valid range of the transition parameter, based on cumulative expected gains obtained from the gain vectors at the next time point; and
a first generation section that generates gain vectors for the target time point from the gain vectors for the next time point, using the transition parameter,
wherein the gain vectors are used to calculate cumulative expected gains in which transition from a current state to a next state occurs in response to an action.

2. The generation apparatus according to claim 1, wherein the first determination section determines a value of the transition parameter for which the cumulative expected gains obtained from the gain vectors at the next time point become equal to or less than a predetermined reference.

3. The generation apparatus according to claim 1, wherein the first determination section determines a value of the transition parameter that minimizes the cumulative expected gains obtained from the gain vectors for the next time point.

4. The generation apparatus according to claim 1, further comprising an initialization section that initializes gain vectors for a future time point; wherein
the generation apparatus generates the gain vectors for the target time point, going back from the future time point.

5. The generation apparatus according to claim 1, wherein
the acquisition section acquires a set of gain vectors for the next time point that includes at least one gain vector for the next time point;
the first determination section determines a value of the transition parameter for each gain vector included in the set of gain vectors for the next time point; and
for each gain vector included in the set of gain vectors for the next time point, the first generation section generates a gain vector for the target time point using the transition parameter and adds the gain vector to a set of the gain vectors for the target time point.

6. The generation apparatus according to claim 1, wherein the first determination section determines a transition probability from each state at the target time point to each state at the next time point, from a valid range of the transition probability.

7. The generation apparatus according to claim 6, wherein the first determination section determines the transition probability by linear programming, from the valid range of the transition probability, the range being expressed by a linear inequality of the transition probability.

8. The generation apparatus according to claim 6, wherein the first determination section determines the valid range of the transition probability as being from a reference value up to a constant multiple of a reference value.

9. The generation apparatus according to claim 5, further comprising an elimination section that eliminates a gain vector that does not maximize a value within a probability distribution range of each state, from the set of the gain vectors for the target time point generated by the first generation section.

10. The generation apparatus according to claim 9, wherein the elimination section eliminates a gain vector that does not maximize a value of the cumulative expected gains in a predetermined probability distribution within the range of probability distribution of each state, from the set of the gain vectors for the target time point generated by the first generation section.

11. The generation apparatus according to claim 1, wherein, in response to each of multiple actions performed at the target time point, the first generation section generates the gain vectors for the target time point based on immediate gains expected from a state transition that occurs in response to the action in each state and cumulative expected gains in a destination state of the gain vectors for the next time point.

12. The generation apparatus according to claim 1, wherein said apparatus is implemented by a program of instructions executable by a computer tangibly embodied in one or more computer readable program storage devices.

13. A selection apparatus that selects an action in a transition model, the apparatus comprising:
a set acquisition section that acquires a set of gain vectors for a target time point that include a cumulative expected gains obtained for and after the target time point, for each state at the target time point;
a probability acquisition section that acquires an assumed probability of being in each state at the target time point;
a selection section that selects a gain vector from the set of gain vectors based on the set of gain vectors and the assumed probability;
an output section that selects and outputs an action corresponding to the selected gain vector;
a second determination section that determines a value of a transition parameter used to transition from the target time point to a next time point, from a valid range of the transition parameter; and
a second generation section that generates an assumed probability of being in each state at the next time point after to the target time point, using the transition parameter,
wherein a transition from a current state to a next state occurs in response to an action.

14. The selection apparatus according to claim 13, wherein the second determination section determines a value of the transition parameter for which the cumulative expected gains obtained from the selected gain vector become equal to or less than a predetermined reference.

15. The selection apparatus according to claim 13, wherein the second determination section determines a value of the transition parameter that minimizes the cumulative expected gains obtained from the selected gain vector.

16. The selection apparatus according to claim 13, further comprising a generation apparatus that generates gain vectors for calculating cumulative expected gains for the transition from a current state to a next state, wherein the set acquisition section acquires a set of gain vectors generated by the generation section.

17. The selection apparatus according to claim 13, wherein said apparatus is implemented by a program of instructions executable by a computer tangibly embodied in one or more computer readable program storage devices.

18. A method of generating gain vectors for calculating cumulative expected gains in a transition model, the method comprising:
acquiring gain vectors for a time point next to a target time point that include cumulative expected gains for and after the next time point for each state at the next time point;
determining a value of a transition parameter used for transitioning from the target time point to the next time point, from a valid range of the transition parameter, based on the cumulative expected gains from the gain vectors for the next time point; and
generating the gain vectors for the target time point from the gain vectors for the next time point, using the transition parameter,
wherein a transition from a current state to a next state occurs in response to an action.

19. A method of selecting an action in a transition model, the method comprising:
acquiring a set of gain vectors for a target time point that include cumulative expected gains for and after the target time point, for each state at the target time point;
acquiring an assumed probability of being in each state at the target time point;
selecting a gain vector from the set of gain vectors based on the set of gain vectors and the assumed probability;
selecting and outputting an action corresponding to the selected gain vector;
determining a value of a transition parameter used for transitioning from the target time point to a next time point, from a valid range of the transition parameter; and
generating an assumed probability of being in each state at the next time point after the target time point, using the transition parameter,
wherein a transition from a current state to a next state occurs in response to an action.
